(19) United States
(12) Patent Application Publication
(10) Pub. No.: US 2006/0190866 A1
(43) Pub. Date: Aug. 24, 2006

(54) Resistance extraction for hierarchical circuit artwork

(76) Inventors: Stephen R. Herbener, Fort Collins, CO (US); Ryan Keener, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/042,428

(22) Filed: Jan. 25, 2005

(51) Int. Cl. G06F 17/50

(52) U.S. Cl. 716/5

(57) ABSTRACT

In one embodiment, a method is disclosed for extracting resistance from hierarchical circuit artwork having parent and child circuit blocks. In accordance with the method, and for each child block, at least one portion of signal trace artwork to which a parent circuit block may connect is identified; the identified portions of signal trace artwork are marked as deferred artwork; and resistance is extracted for the child circuit block less the deferred artwork. For each of the identified portions of signal trace artwork, a port is defined where deferred artwork adjoins artwork for which resistance has been extracted. For each parent circuit block, deferred artwork is promoted from child circuit blocks to which the parent circuit block connects; and resistance is extracted for the parent circuit block, including the promoted artwork.

### BACKGROUND

Many integrated circuit (IC) design houses use a hierarchical method for developing circuit layouts. A hierarchical design method is desirable because it can break a large design into smaller more manageable pieces (i.e., blocks) which can then be assigned to different design teams for further development.

At some point in the design process, software tools are used to extract artwork (i.e., physical patterns of IC components and signal traces) for implementing an IC design. Because signal traces may not be assigned a resistance or capacitance value at the design level, and because physical constraints do not allow for a one-to-one theoretical conversion of an IC design to IC artwork, additional software tools are typically used to extract the resistance and capacitance of an IC design's corresponding artwork. The extracted values are then used for timing and other analyses to determine whether an IC's artwork adequately implements the IC's design.

### SUMMARY OF THE INVENTION

In one embodiment, a method is disclosed for extracting resistance from hierarchical circuit artwork comprised of parent and child circuit blocks. The method comprises, for each child circuit block, identifying at least one portion of signal trace artwork to which a parent circuit block may connect; marking the identified portions of signal trace artwork as deferred artwork; and extracting resistance for the child circuit block less the deferred artwork. For each of the identified portions of signal trace artwork, a port is defined where deferred artwork adjoins artwork for which resistance has been extracted. The method also comprises, for each parent circuit block, promoting deferred artwork from child circuit blocks to which the parent circuit block connects; and extracting resistance for the parent circuit block, including the promoted artwork.

Other embodiments are also disclosed.

### BRIEF DESCRIPTION OF THE DRAWINGS

Illustrative embodiments of the invention are illustrated in the drawings, in which:

FIG. 1 illustrates an exemplary method for extracting resistance from hierarchical circuit artwork;

FIG. 2 illustrates an exemplary child circuit block of hierarchical circuit artwork; and

FIG. 3 illustrates exemplary attachments of parent circuit blocks to the child circuit block shown in FIG. 2.

### DETAILED DESCRIPTION

One way to extract resistance from hierarchical circuit artwork is via a “hierarchical” method. Under a hierarchical method, resistances are independently extracted from child and parent circuit blocks, and resistances extracted for signal traces that cross child/parent block boundaries are stitched together as best as possible (and often by just coupling them in series). Although a hierarchical resistance extraction method often provides good data management (i.e., an IC's entire design does not have to be loaded into memory), resistance extraction for each circuit block is undertaken with little or no knowledge of how signal traces are coupled to signal traces of another block. Further, an inherent assumption is that the signal traces of a child circuit block will always connect to a parent circuit block in the same way. However, when more than one instance of a child circuit block is incorporated into an IC design, different instances of the child circuit block may connect to different parent circuit blocks in different ways. Consider, for example, a modular adder having a plurality of adder cells that are linked in a tiered fashion. Due to routing constraints, each adder cell may have to connect to a common parent circuit block in a slightly different way, and thus, when resistance is merely extracted for the child circuit block, rather than for each separate instance of the child circuit block, extracted resistances for the adder as a whole may be incorrect.

Another way to extract resistance from hierarchical circuit artwork is via a “flat” method. Under a flat method, hierarchical circuit artwork is flattened. That is, parent circuit blocks are spliced with their child circuit blocks and pushed into the same context. Resistance extraction is then performed for the child and parent blocks as part of the same effort, and more accurate resistances are extracted. However, the greater accuracy of the flat resistance extraction method is achieved with a cost—i.e., the need to store and manipulate a much larger data set. As the manipulated data set grows larger, the speed of resistance extraction suffers.

Some software tools attempt to resolve the issue of manipulating a large “flattened” data set by partitioning the data set into more manageable pieces. Resistance is then extracted for each piece, and the pieces are stitched back together. However, in doing so, the correspondence between extracted resistance networks and parent and child circuit blocks can become blurred (or can even be lost), and the tracking of different child circuit block instances can become difficult.

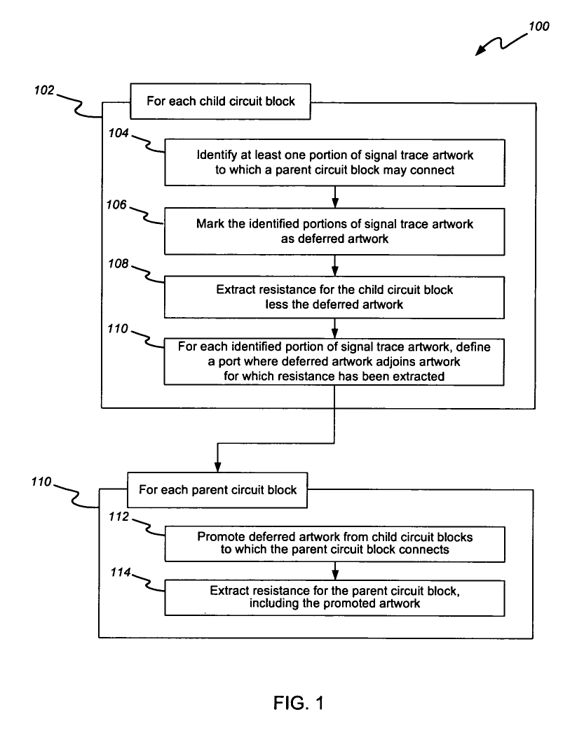

FIG. 1 illustrates an alternate method 100 for extracting resistance from hierarchical circuit artwork. In accordance with the method 100, the following actions 102 are undertaken for each child circuit block. First, at least one portion of signal trace artwork to which a parent circuit block may connect is identified 104 and marked 106 as deferred artwork. The resistance for the child circuit block, less its deferred artwork, is then extracted 106. Also, for each identified portion of signal trace artwork, a port is defined 108 where the deferred artwork adjoins artwork for which resistance has been extracted.

For each parent circuit block, the following actions 110 are performed. First, the deferred artwork from child circuit blocks to which the parent circuit block connects is promoted 112 to the parent circuit block context. Resistance is then extracted 114 for the parent circuit block, including the promoted artwork.

If desired, the ports identified during the course of executing the method 100 may be used to later couple the extracted resistance networks of parent and child circuit blocks.

Note that in some hierarchical IC designs, a single circuit block may have multiple roles. That is, the circuit block may be a child of one circuit block and a parent to another circuit block. In these cases, some portions of signal trace artwork may be promoted to the circuit block, while other portions of signal trace artwork may be identified as deferred artwork. After identifying all promoted and deferred artwork, resistance is then extracted for these blocks along with any promoted artwork, but less their deferred artwork.

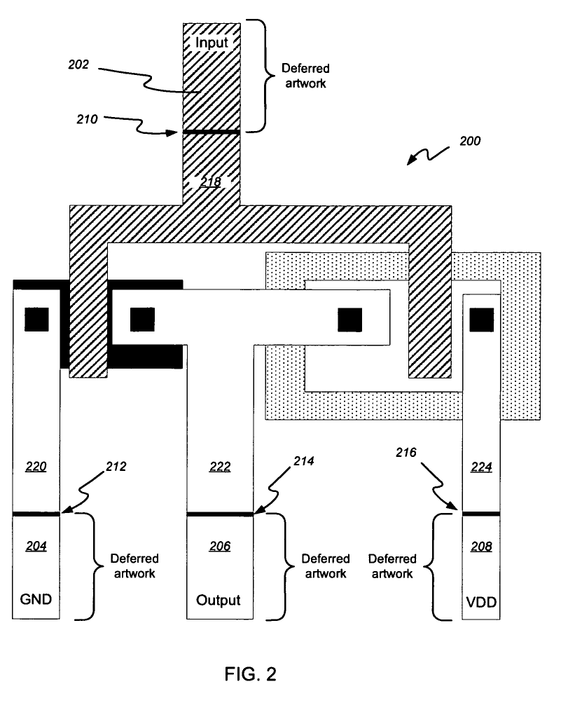

FIG. 2 illustrates an exemplary child circuit block 200 wherein deferred artwork 202, 204, 206, 208 has been identified. In some cases, software may identify artwork for deferral by identifying signal traces at the “outside” or edges of the block, or by identifying special layers that allow or disallow over-the-cell routing. Typically, deferred artwork will correspond to signal traces identified as input, output, power (VDD) and ground (GND) connections.

Ports 210, 212, 214, 216 have also been defined in FIG. 2. The ports 210-216 are defined where non-deferred artwork 218, 220, 222, 224 adjoins deferred artwork 202-208. As previously mentioned, the ports 210-216 serve as tags to define how extracted resistance networks for child and parent circuit blocks should be coupled to one another.

When extracting resistance for the child circuit block 200, resistances are not extracted for its deferred artwork 202-208. Resistances for the child circuit block's ports 210-216 may be extracted along with the resistances of the child circuit block 200. Alternately, the ports 210-216 may be promoted to parent contexts along with the deferred artwork which they abut, and resistances for the ports 210-216 may be extracted along with resistances for the parent circuit blocks to which they are promoted. In yet another alternative, ports 210-216 may be defined as lines having no area, or as signal trace slices covering very little area, such that their resistances may simply be ignored.

In some cases, a via may appear in or about the vicinity of artwork that is to be deferred. In these cases, it may sometimes be desirable to include the via within deferred artwork, or to position a port so that it coincides with the via.

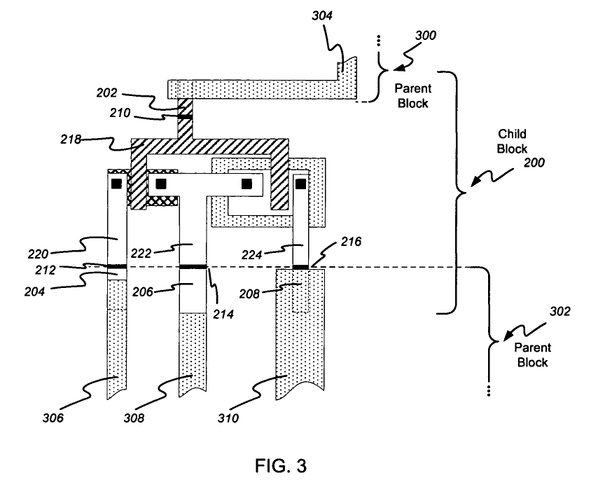

FIG. 3 illustrates exemplary connections of parent circuit blocks 300, 302 to one particular instance of the child circuit block 200. Note that the parent circuit blocks 300, 302 attach to the deferred artwork 202-208 of the child circuit block 200 in various ways. The attachment geometries may be determined or influenced by design constraints, but are often determined by implementation constraints. That is, place and route software may simply determine the most effective way to attach blocks (e.g., based on parasitic factors, route lengths, chip area, or timing).

Depending on the attachment geometry between parent and child signal traces, the extracted resistance network for the parent block may change. For example, the simplest attachment geometry may be the butt connection, as shown between deferred artwork 206 and parent trace 308. In this case, the extracted resistance may be a single resistance value for the parent trace 308 and deferred artwork 206, or a pair of series resistances (e.g., one each for the parent trace 308 and deferred artwork 206). In either case, the full value of the deferred artwork's resistance is extracted when extracting the resistances for the parent circuit block 302.

Another attachment geometry is the overlap connection. One example of this connection is shown between deferred artwork 204 and parent trace 306. For this connection, a single resistance or pair of series resistances may again be extracted. However, note that a portion of the deferred artwork 204 adds no additional resistance to the parent trace 306, as it is subsumed by the parent trace 306.

An alternate overlap connection is shown between deferred artwork 208 and parent trace 310. In this case, the resistance of the deferred artwork 208 is entirely subsumed by that of the parent trace 310.

Yet another overlap connection is shown between deferred artwork 202 and parent trace 304. In this case, parent trace 304 crosses over the deferred artwork 202. The extracted resistance network would therefore be a T-network.

Various other types of attachment geometries also exist. For example, multiple signal traces of a parent circuit block could connect to the same piece of deferred/promoted artwork. In such a case, a Pi or even more complex resistance network might be extracted. In any event, it should be clear that the manner in which a parent circuit block connects to a child circuit block can have a significant bearing on the resistance value or resistance network that is extracted for a pair or group of signal traces that cross block boundaries. The method 100 can be used to more accurately model and extract these resistances.

Note that, although child circuit block 200 is shown in its entirety in FIG. 3, the resistance extraction for parent circuit block 300 may be performed after promoting only one piece of deferred artwork (i.e., deferred artwork 202). Thus, the rest of the child circuit block 200 does not need to be loaded into memory while resistances are extracted for parent circuit block 300.

In some hierarchical IC designs, multiple instances of a circuit block may appear in the design. In these cases, the method 100 may promote the child's deferred artwork into two or more parent circuit block contexts. For example, if multiple instances of the child circuit block 200 were included in an IC design, deferred artwork 202 might be promoted to a first parent circuit block wherein a parent trace overlaps the deferred artwork 202. The deferred artwork 202 may then be promoted to a second parent circuit block wherein a parent trace abuts the deferred artwork 202. As a result, the resistances extracted for the deferred artwork 202 and parent circuit blocks in these different contexts may differ.

In one embodiment, the actions of the method 100 are embodied in sequences of instructions stored on a number of machine-readable media (e.g., one or more fixed disks, removable media such as compact discs (CDs) or digital versatile discs (DVDs), random-access or read only memories, or any combination thereof, whether in a single location, on a single machine, or distributed across a network).

After executing the method 100, hierarchical circuit artwork may be optimized in response to analysis of extracted resistances; and a manufactured IC may include such optimizations. The analysis performed on (or using) extracted resistances may variously comprise analysis such as power analysis or timing analysis.

What is claimed is:

1. A method for extracting resistance from hierarchical circuit artwork comprised of parent and child circuit blocks, comprising:
for each child circuit block,
identifying at least one portion of signal trace artwork to which a parent circuit block may connect;
marking the identified portions of signal trace artwork as deferred artwork;
extracting resistance for the child circuit block less the deferred artwork; and
for each identified portion of signal trace artwork, defining a port where deferred artwork adjoins artwork for which resistance has been extracted; and
for each parent circuit block,
promoting deferred artwork from child circuit blocks to which the parent circuit block connects; and
extracting resistance for the parent circuit block, including the promoted artwork.

2. The method of claim 1, wherein at least one child circuit block is a parent circuit block to at least one other child circuit block.

3. The method of claim 1, further comprising, for at least one child circuit block, promoting at least portions of its deferred artwork to at least two different parent circuit blocks.

4. The method of claim 1, wherein the deferred artwork comprise a via.

5. The method of claim 1, wherein attempts are made to define ports to coincide with vias.

6. The method of claim 1, wherein ports are defined as signal trace slices for which resistances are not extracted.

7. The method of claim 1, wherein resistances for ports are extracted in the child circuit blocks in which they are defined.

8. The method of claim 1, wherein ports are promoted along with the deferred artwork which they abut, and wherein resistances for ports are extracted in parent circuit blocks to which they are promoted.

9. The method of claim 1, wherein extracting resistance for at least one parent circuit block comprises extracting resistance for a signal trace of the parent circuit block that subsumes promoted artwork.

10. The method of claim 1, wherein extracting resistance for at least one parent circuit block comprises extracting resistance for a signal trace of the parent circuit block that overlaps promoted artwork.

11. The method of claim 1, wherein extracting resistance for at least one parent circuit block comprises extracting resistance for multiple signal traces of the parent circuit block, each of which connect to the same piece of promoted artwork.

12. The method of claim 1, further comprising, coupling, via said ports, i) extracted resistance networks of child circuit blocks to ii) extracted resistance networks of parent circuit blocks.

13. A number of machine-readable media having stored thereon sequences of instructions that, when executed by a machine, cause the machine to extract resistance from hierarchical circuit artwork comprised of parent and child circuit blocks by performing actions comprising:
for each child circuit block,
identifying at least one portion of signal trace artwork to which a parent circuit block may connect;
marking the identified portions of signal trace artwork as deferred artwork;
extracting resistance for the child circuit block less the deferred artwork; and
for each identified portion of signal trace artwork, defining a port where deferred artwork adjoins artwork for which resistance has been extracted; and
for each parent circuit block,
promoting deferred artwork from child circuit blocks to which the parent circuit block connects; and
extracting resistance for the parent circuit block, including the promoted artwork.

14. The machine-readable media of claim 13, wherein the actions performed by the machine in response to execution of the instructions further comprise, for at least one child circuit block, promoting at least portions of its deferred artwork to at least two different parent circuit blocks.

15. The machine-readable media of claim 13, wherein ports are defined as signal trace slices for which resistances are not extracted.

16. The machine-readable media of claim 13, wherein extracting resistance for at least one parent circuit block comprises extracting resistance for a signal trace of the parent circuit block that subsumes promoted artwork.

17. The machine-readable media of claim 13, wherein extracting resistance for at least one parent circuit block comprises extracting resistance for a signal trace of the parent circuit block that overlaps promoted artwork.

18. The machine-readable media of claim 13, wherein extracting resistance for at least one parent circuit block comprises extracting resistance for multiple signal traces of the parent circuit block, each of which connect to the same piece of promoted artwork.

19. The machine-readable media of claim 13, wherein the actions performed by the machine in response to execution of the instructions further comprise coupling, via said ports, i) extracted resistance networks of child circuit blocks to ii) extracted resistance networks of parent circuit blocks.

20. An integrated circuit produced by:
generating hierarchical circuit artwork comprised of parent and child circuit blocks;
for each child circuit block,
identifying at least one portion of signal trace artwork to which a parent circuit block may connect;
marking the identified portions of signal trace artwork as deferred artwork;
extracting resistance for the child circuit block less the deferred artwork; and
for each identified portion of signal trace artwork, defining a port where deferred artwork adjoins artwork for which resistance has been extracted;
for each parent circuit block,
promoting deferred artwork from child circuit blocks to which the parent circuit block connects; and
extracting resistance for the parent circuit block, including the promoted artwork; and
optimizing the hierarchical circuit artwork in response to analysis of the extracted resistances.
